(19) United States
(12) Patent Application Publication
(10) Pub. No.: US 2026/0336389 A1
(43) Pub. Date: Oct. 29, 2026

(54) WORK VEHICLE

(71) Applicant: KOMATSU LTD., Tokyo (JP)

(72) Inventors: Yuta Hoshino, Tokyo (JP); Yuuki Ishikawa, Tokyo (JP); Ryousuke Maeda, Tokyo (JP); Masafumi Kuroda, Tokyo (JP); Shuhei Kousaka, Tokyo (JP)

(73) Assignee: KOMATSU LTD., Tokyo (JP)

(21) Appl. No.: 19/123,380

(22) PCT Filed: Sep. 27, 2023
(86) PCT No.: PCT/JP2023/035164

§ 371 Date: Apr. 22, 2025

(30) Foreign Application Priority Data
Nov. 14, 2022 (JP) 2022-181825

(51) Int. Cl. B60K 15/035; B60K 15/03; B60P 1/04; H01Q 1/32; H01Q 9/30

(52) U.S. Cl. CPC B60K 15/035; B60P 1/04; H01Q 1/3208; H01Q 9/30; B60K 2015/03315

(57) ABSTRACT

A work vehicle equipped with a drive source using hydrogen as fuel includes a hydrogen tank configured to store the hydrogen, and a hydrogen discharge tube including a discharger configured to discharge an evaporated gas from the hydrogen tank, and the discharger discharges the evaporated gas to a space above the work vehicle.

### TECHNICAL FIELD

The present invention relates to a work vehicle.

The present invention claims the priority based on Japanese Patent Application No. 2022-181825 filed on Nov. 14, 2022 in Japan, the content of which is incorporated herein by reference.

### BACKGROUND ART

To aim for carbon neutrality, it is urgent to achieve zero emission from mining machines, construction machines, and the like. One technology for achieving zero emission is fuel cell systems. For example, a fuel cell system includes a fuel cell (FC), a battery, and a hydrogen tank that stores hydrogen as fuel. Hydrogen, which is fuel, has a very small ignition energy, a very wide combustion concentration range, and a very high combustion rate as compared with other fuels such as propane. It is therefore necessary to pay particular attention to handling of hydrogen. For example, to use a high-pressure gas tank, attaching a safety device such as a safety valve to the tank is mandatory in some cases in compliance with regulation. An example of the safety device is a thermal pressure relief device (TPRD), which automatically discharges a gas in a tank into the atmosphere when heat (high temperature) in the event of a fire or the like is detected. For example, when a high-pressure gas tank is used, hydrogen is discharged near the tank because the TPRD is directly attached to the tank. When liquefied hydrogen is used, the liquefied hydrogen stored in the tank and left for a long period is likely to evaporate (boil off). Therefore, to avoid explosion due to an increase in the pressure in the tank, it is necessary to safely discharge the hydrogen into the atmosphere.

For example, Patent Literature 1 discloses a fuel cell vehicle including a driving force generator that generates a driving force by using a hydrogen gas as fuel, a hydrogen tank that stores the hydrogen gas, and a tank container that covers the periphery of the hydrogen tank. The tank container is incorporated in an upper portion of a floor panel with the hydrogen tank accommodated in the tank container. An upper portion of the tank container is provided with an aerodynamic stream discharge port via which the interior of the tank container communicates with the exterior of the fuel cell vehicle. The structure that discharges the hydrogen gas leaking from the hydrogen tank is provided in the vehicle body.

### CITATION LIST

### Patent Literature

PTL 1: JP-A-2010-070028

### SUMMARY OF INVENTION

### Technical Problem

The hydrogen gas having leaked from the hydrogen tank may, however, not be discharged out of the vehicle due to the aerodynamic stream, SO that the hydrogen gas may accumulate in the vehicle body. There is therefore room for improvement in safely discharging the hydrogen into the atmosphere.

To solve the problem described above, an object of the present invention is to provide a work vehicle capable of safely discharging hydrogen into the atmosphere.

### Solution to Problem

A work vehicle according to an aspect of the present invention is a work vehicle equipped with a drive source using hydrogen as fuel and including a hydrogen tank configured to store the hydrogen, and a hydrogen discharge tube including a discharger configured to discharge an evaporated gas from the hydrogen tank, and the discharger discharges the evaporated gas to a space above the work vehicle.

### Advantageous Effects of Invention

According to the aspect described above, the hydrogen can be safely released into the atmosphere.

### BRIEF DESCRIPTION OF DRAWINGS

FIG. 1 is a perspective view of a dump truck according to an embodiment.

FIG. 2 is a side view of the dump truck according to the embodiment.

FIG. 3 is a front view of the dump truck according to the embodiment.

FIG. 4 is a block diagram of a hydrogen supply system according to the embodiment.

### DESCRIPTION OF EMBODIMENTS

An embodiment of the present invention will be described below with reference to the drawings. The embodiment will be described with reference to a case where a dump truck, which is a transportation vehicle that travels at a work site such as a mine and transports a load, is presented as a work vehicle that constitutes a hydrogen supply system.

### Dump Truck

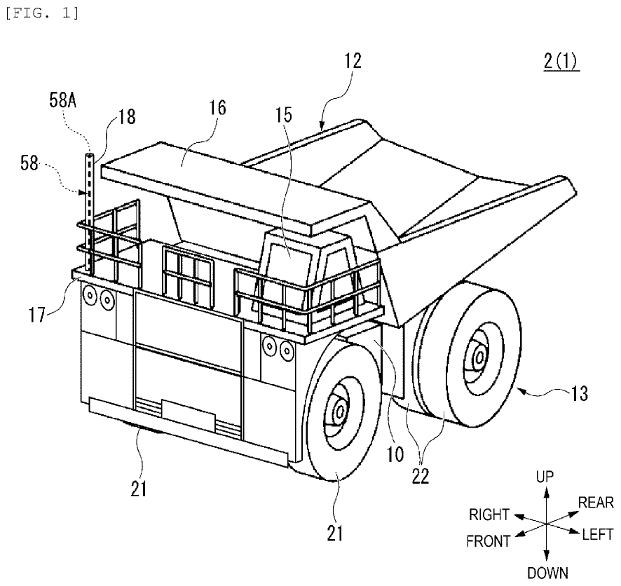

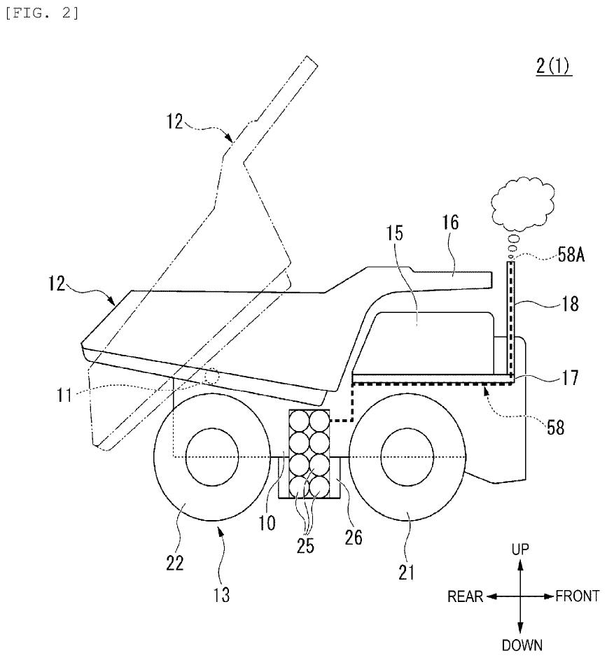

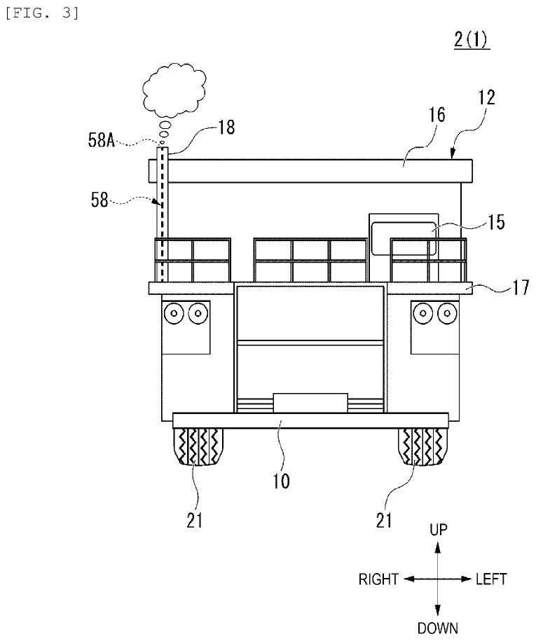

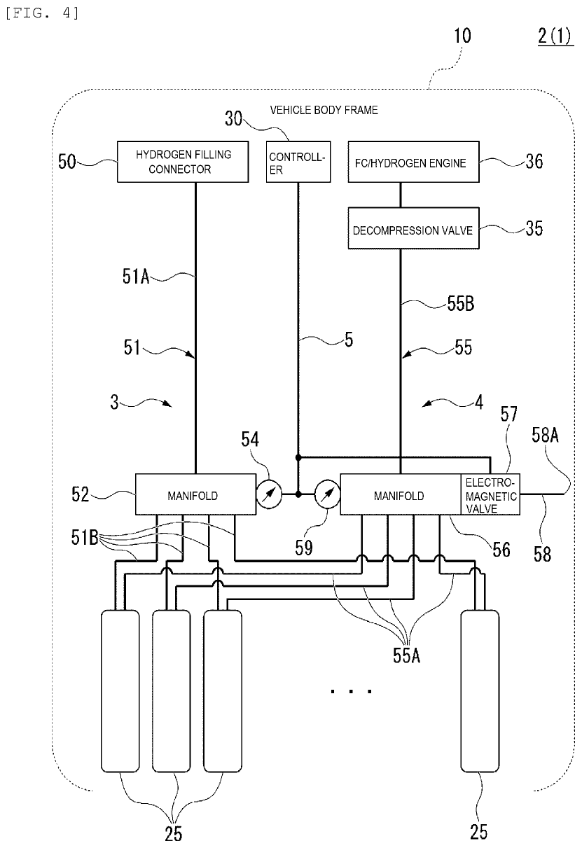

FIG. 1 is a perspective view of a dump truck 2 according to an embodiment. FIG. 2 is a side view of the dump truck 2 according to the embodiment. FIG. 3 is a front view of the dump truck 2 according to the embodiment. FIG. 4 is a block diagram of a hydrogen supply system 1 according to the embodiment.

Referring to FIGS. 1 to 4 together, the dump truck 2 is equipped with a drive source 36 (equivalent to FC/hydrogen engine) using hydrogen as fuel. The dump truck 2 includes hydrogen tanks 25, which each store hydrogen, and a hydrogen discharge tube 58, which has a discharger 58A, which discharges a hydrogen gas (evaporated gas) from any of the hydrogen tanks 25.

The dump truck 2 further includes a vehicle body frame 10, which is equipped with the drive source 36 using hydrogen as fuel, a dump body 12 (equivalent to vessel), which is pivotably coupled to the vehicle body frame 10 via a pivotal section 11 and accommodates a load, and a traveling apparatus 13, which supports the vehicle body frame 10. For example, the dump truck 2 may be an unmanned dump truck that requires no driver's driving operation but is driven autonomously, or may be a manned dump truck driven based on a driver's driving operation.

In the following description, the forward direction (front side of vehicle body), the rearward direction (rear side of vehicle body), and the width direction (rightward-leftward direction of vehicle body) of the dump truck 2 are referred to as a “front side of the vehicle (one side in vehicle's frontward-rearward direction)”, a “rear side of the vehicle (other side in vehicle's frontward-rearward direction)”, and a “vehicle width direction”, respectively. The vehicle width direction may also be referred to as a “left side (one side in vehicle width direction)” or a “right side (other side in vehicle width direction)”. The right-hand side in the direction in which the dump truck 2 moves forward is referred to as the right side, and the left-hand side in the direction in which the dump truck 2 moves forward is referred to as the left side. The vehicle's upward-downward direction (vehicle body's upward-downward direction), the vehicle's upper side (vehicle body's upper side), and vehicle's lower side (vehicle body's lower side) of the dump truck 2 are simply referred to as an “upward-downward direction”, an “upper side”, and a “lower side”, respectively. In the example shown in the drawings, the dump truck 2 is located on a horizontal surface (horizontal ground). The vehicle's upward-downward direction (vehicle body's upward-downward direction), the vehicle's upper side (vehicle body's upper side), and the vehicle's lower side (vehicle body's lower side) of the dump truck 2 coincide with the upward-downward direction (vertical direction), the vertically upper side, and the vertically lower side in the state in which the dump truck 2 is located on the horizontal surface, respectively.

The vehicle body frame 10 extends in the vehicle's frontward-rearward direction. The vehicle body frame 10 pivotably supports the dump body 12 via the pivotal section 11. The pivotal section 11 is a section including a shaft (equivalent to pivotal center axis of dump body 12) extending in the vehicle width direction on the vehicle body frame 10. The vehicle body frame 10 is supported by the traveling apparatus 13.

The dump body 12 is pivotably coupled to the vehicle body frame 10 via the pivotal section 11. The dump body 12 is a member (equivalent to cargo bed) that accommodates a load. At least a portion of the dump body 12 is disposed above the vehicle body frame 10. The dump body 12 can perform a dumping operation and a lowering operation.

The dumping operation means the operation of separating the dump body 12 from the vehicle body frame 10 and tilting the dump body 12 in a dumping direction. The dumping direction is rearward of the vehicle body frame 10. In the embodiment, the dumping operation includes raising the front end of the dump body 12 and tilting the dump body 12 rearward. The dumping operation tilts a loading surface of the dump body 12 rearward and downward.

The lowering operation means the operation of bringing the dump body 12 close to the vehicle body frame 10. The lowering operation is the operation in the direction opposite the direction of the dumping operation. In the embodiment, the lowering operation includes lowering the front end of the dump body 12.

The dumping operation and the lowering operation adjusts the posture of the dump body 12 to a dump posture and a loading posture. The dumping posture refers to a posture in which the dump body 12 is lifted. The loading posture refers to a posture in which the dump body 12 is lowered. In the example shown in FIG. 2, the solid line indicates the dump body 12 in the loading posture, and the two-dot chain line indicates the dump body 12 in the dumping posture.

For example, when performing earth removal, the dump body 12 performs the dumping operation so as to change the posture thereof from the loading posture to the dumping posture. When a load has been accommodated in the dump body 12, the dumping operation discharges the load rearward via the rear end of the dump body 12. On the other hand, when performing loading, the posture of the dump body 12 is adjusted to the loading posture.

The dump body 12 includes a protector 16, which protects a cab 15 from above. The protector 16 is disposed so as to cover the cab 15 from above when the dump body 12 is in the loading posture. The protector 16 is provided at the front end of the dump body 12. The protector 16 is disposed above the cab 15. The protector 16 extends in the vehicle width direction. The cab 15 is disposed, for example, on the vehicle's left side of the center in the vehicle width direction.

The cab 15 is supported by a platform 17. The platform 17 is provided above a front portion of the vehicle body frame 10. The platform 17 is provided to secure a scaffold that allows an operator to get on and off the cab 15. The platform 17 is provided further to secure a scaffold used for maintenance of equipment incorporated in the dump truck 2. The platform 17 is disposed below the protector 16. The platform 17 is disposed above wheels 21 and 22. The platform 17 extends in the vehicle width direction. The platform 17 is formed in the shape of a plate parallel to the vehicle's frontward-rearward direction and the vehicle width direction.

The traveling apparatus 13 supports the vehicle body frame 10. The traveling apparatus 13 causes the dump truck 2 to travel. The traveling apparatus 13 moves the dump truck 2 forward or rearward. At least a portion of the traveling apparatus 13 is disposed below the vehicle body frame 10. The traveling apparatus 13 includes multiple wheels 21 and 22. The multiple wheels 21 and 22 includes front wheels 21 and rear wheels 22 disposed rearward of the front wheels 21.

The front wheels 21 are wheels to be steered to change the traveling direction of the dump truck 2. The front wheels 21 are configured with a pair of right and left wheels. The pair of right and left front wheels 21 are disposed with a gap in the vehicle width direction via a front portion of the vehicle body frame 10. The front wheels 21 are provided on the right and left sides one on each side (two in total).

The rear wheels 22 are drive wheels driven by the drive source 36. The rear wheels 22 are configured with a pair of right and left wheels. The pair of right and left rear wheels 22 are disposed with a gap in the vehicle width direction via a rear portion of the vehicle body frame 10. The rear wheels 22 are provided on the right and left sides two on each side (four in total).

The dump truck 2 further includes an antenna pole 18 for transmission and reception of radio waves. In the present embodiment, the antenna pole 18 is provided at a right front end portion of the platform 17. The antenna pole 18 is disposed at a location opposite the driver's seat 15 in the vehicle width direction.

The antenna pole 18 extends along the vehicle's upward-rearward direction. The antenna pole 18 extends from the upper surface of the platform 17 upward beyond the upper end of the dump body 12. The upper end of the antenna pole 18 is higher than the upper end of the dump body 12.

Note that the antenna pole 18 is not necessarily shaped or disposed as described above. For example, the antenna pole 18 may be provided at the center of a front end portion of the platform 17. For example, the antenna pole 18 may be disposed at a location on the same side as the driver's seat 15 in the vehicle width direction. For example, the antenna pole 18 can be shaped and disposed differently in accordance with design specifications.

### Hydrogen Tank

The dump truck 2 includes the hydrogen tanks 25, which store hydrogen as fuel. The hydrogen tanks 25 are provided in the vehicle body frame 10. In the present embodiment, the hydrogen tanks 25 are supported by the vehicle body frame 10 via a bracket 26. For example, the hydrogen tanks 25 are detachably linked to a box-shaped holder attached to the bracket 26.

For example, the hydrogen tanks 25 each have a cylindrical shape. The multiple hydrogen tanks 25 are provided so as to be arranged in the vehicle's upward-downward direction and the vehicle's frontward-rearward direction in the side view. In the example shown in FIG. 2, eight hydrogen tanks 25 (example of multiple hydrogen tanks) are arranged in four rows in the upward-downward direction and in two columns in the frontward-rearward direction.

Note that the shape, number, and arrangement of the hydrogen tanks 25 are not limited to those described above. For example, the hydrogen tanks 25 may each have a flat shape. For example, the number of the hydrogen tanks 25 may be seven or smaller or nine or greater. For example, the hydrogen tanks 25 may be stacked in the vehicle width direction. For example, the shape, number, and arrangement of the hydrogen tanks 25 can be changed in accordance with the design specifications.

### Hydrogen Discharge Tube

The dump truck 2 includes the hydrogen discharge tube 58, which includes the discharger 58A, which discharges the hydrogen gas (evaporated gas) from the hydrogen tanks 25. The discharger 58A is a portion (opening) of the hydrogen discharge tube 58 through which the hydrogen gas is discharged. The discharger 58A discharges the hydrogen gas to the space above the dump truck 2.

In the present embodiment, the discharger 58A is disposed at a front end portion of the dump truck 2. The discharger 58A is disposed at a position where the discharger 58A does not overlap the dump body 12 in the plan view (viewed in vehicle's upward-downward direction). The discharger 58A is disposed at a position where the discharger 58A overlaps with a right front end portion of the platform 17 in the plan view.

The discharger 58A is disposed forward of the front end of the dump body 12 in the side view. The discharger 58A is located forward of the front end of the protector 16 when the dump body 12 is in the loading posture. The discharger 58A is disposed upward of the upper end of the dump body 12 in the front view. The discharger 58A is located upward of the upper end of the protector 16 when the dump body 12 is in the loading posture.

The discharger 58A is disposed as a portion of the antenna pole 18. For example, the discharger 58A is preferably disposed so as not to hinder the radio waves transmitted from and received by the antenna pole 18. The discharger 58A is located above the upper end of the dump body 12, as the upper end of the antenna pole 18. The discharger 58A discharges the hydrogen gas at a location higher than the upper end of the dump body 12 into the space above the dump truck 2.

The hydrogen discharge tube 58 passes along the lower surface of the platform 17. In the example shown in FIG. 2, the hydrogen discharge tube 58 extends from a portion facing the hydrogen tanks 25 (portion branching off hydrogen supply manifold 56) toward the rear end of the platform 17, and then extends to the front end of the platform 17 along the lower surface of a right end portion of the platform 17.

The hydrogen discharge tube 58 passes along the lower surface of the platform 17 and then extends along the antenna pole 18 to the upper end of the antenna pole 18. The upper end of the hydrogen discharge tube 58 functions as the discharger 58A (equivalent to upper end opening), which discharges the hydrogen gas (evaporated gas) from the hydrogen tanks 25 upward.

For example, the hydrogen discharge tube 58 may be configured with a tube having an outer diameter greater than or equal to 10 mm. For example, the hydrogen discharge tube 58 is detachably linked, for example, to the lower surface of the platform 17 via a linkage member (not shown) such as a P-shaped clamp. For example, multiple linkage members are provided at intervals in the direction along the hydrogen discharge tube 58. For example, the multiple linkage members are provided so as to link the hydrogen discharge tube 58 to the platform 17 and the antenna pole 18.

Note that the linkage members are not necessarily configured as described above. For example, the linkage members may be provided so as to link the hydrogen discharge tube 58 at locations different from the lower surface of the platform 17. For example, the aspect in which the linkage members are disposed can be changed in accordance with the design specification.

### Hydrogen Supply System

Elements that constitute the hydrogen supply system 1 (example of system) are incorporated in the vehicle body frame 10.

The following elements are incorporated in the vehicle body frame 10: a controller 30; a decompression valve 35; the drive source 36 (equivalent to FC/hydrogen engine); a hydrogen filling connector 50; the hydrogen tanks 25; a hydrogen filling manifold 52; a hydrogen filling pressure sensor 54; a hydrogen supply manifold 56; an electromagnetic valve 57; the hydrogen discharge tube 58 (specifically, portion of hydrogen discharge tube 58 that is opposite discharger 58A); and a hydrogen supply pressure sensor 59.

A harness 5 is configured to deliver control signals from the controller 30 incorporated in the vehicle body frame 10 to the elements that constitutes the system. For example, the harness 5 includes multiple electric wires (electric wire bundle, for example).

One end of the harness 5 is connected to the controller 30. For example, the controller 30 includes a processing section that is a processor such as a CPU, a storage section such as a RAM, a ROM, or a combination thereof, and an input/output section. The processing section controls the operations of the elements that constitute the system. The storage section stores a computer program for realizing the functions the processing section and information necessary for processes carried out by the processing section. The input/output section is an interface circuit that interfaces the controller 30 with other apparatuses.

The hydrogen supply system 1 includes a hydrogen filling unit 3, which fills the hydrogen tanks 25 with hydrogen as fuel, and a hydrogen supplying unit 4, which supplies the hydrogen in the hydrogen tanks 25 to the drive source 36. In the present embodiment, the hydrogen filling unit 3 and the hydrogen supplying unit 4 are configured to have hydrogen flow paths different from each other.

### Hydrogen Filling Unit

The hydrogen filling unit 3 includes a hydrogen filling tube 51 and the hydrogen filling manifold 52. The hydrogen filling tube 51 includes a first filling section 51A provided upstream from the hydrogen filling manifold 52 and second filling sections 51B provided downstream from the hydrogen filling manifold 52.

For example, the first filling section 51A and the second filling sections 51B are each configured with a metal tube. For example, the first filling section 51A and the second filling sections 51B are each configured with a high-pressure metal tube that can withstand high-pressure hydrogen (about 70 MPa, for example).

The multiple second filling sections 51B are provided in the vehicle body frame 10. For example, the hydrogen filling manifold 52 is provided in a left portion (portion on one side in vehicle width direction) of the vehicle body frame 10. The hydrogen filling manifold 52 has a structure in which one tube (equivalent to first filling section 51A) branches into multiple tubes (equivalent to multiple second filling sections 51B corresponding to multiple hydrogen tanks 25).

The hydrogen filling connector 50 is connected to the hydrogen filling manifold 52 via the first filling section 51A, which constitutes the hydrogen filling tube 51. The hydrogen filling manifold 52 is connected to the hydrogen tanks 25 via the second filling sections 51B, which constitute the hydrogen filling tube 51. The hydrogen tanks 25 are filled with the hydrogen via the hydrogen filling connector 50, the first filling section 51A (equivalent to metal tube), the hydrogen filling manifold 52, and the second filling sections 51B (equivalent to metal tubes).

The hydrogen filling pressure sensor 54 is connected to the hydrogen filling manifold 52. The hydrogen filling pressure sensor 54 measures the pressure in the hydrogen filling manifold 52.

### Hydrogen Supplying Unit

The hydrogen supplying unit 4 includes a hydrogen supply tube 55 and the hydrogen supply manifold 56. The hydrogen supply tube 55 includes first supply sections 55A provided upstream from the hydrogen supply manifold 56 and a second supply section 55B provided downstream from the hydrogen supply manifold 56.

For example, the first supply sections 55A and the second supply section 55B are each configured with a metal tube. For example, the first supply sections 55A and the second supply section 55B are each configured with a high-pressure metal tube that can withstand the high-pressure hydrogen (about 70 MPa, for example).

The multiple first supply sections 55A are provided in the vehicle body frame 10. For example, the hydrogen supply manifold 56 is provided in a right portion (portion on other side in vehicle width direction) of the vehicle body frame 10. The hydrogen supply manifold 56 has a structure in which multiple tubes (equivalent to multiple first supply sections 55A corresponding to multiple hydrogen tanks 25) are merged into one tube (equivalent to second supply section 55B).

The hydrogen tanks 25 are connected to the hydrogen supply manifold 56 via the first supply sections 55A, which constitute the hydrogen supply tube 55. The hydrogen supply manifold 56 is connected to the drive source 36, for example, via the second supply section 55B, which constitutes the hydrogen supply tube 55. The hydrogen is supplied to the drive source 36 via the hydrogen tanks 25, the first supply sections 55A (equivalent to metal tubes) , the hydrogen supply manifold 56, the second supply portion 55B (equivalent to metal tube), and the like.

The hydrogen discharge tube 58 is provided as a tube branching off the hydrogen supply manifold 56. The hydrogen discharge tube 58 discharges the hydrogen gas, into which the hydrogen as fuel vaporizes. The hydrogen discharge tube 58 is connected to the hydrogen supply manifold 56 via the electromagnetic valve 57. For example, in an emergency, the hydrogen gas in the hydrogen supply manifold 56 may be discharged out thereof via the hydrogen discharge tube 58.

The hydrogen supply pressure sensor 59 is connected to the hydrogen supply manifold 56. The hydrogen supply pressure sensor 59 measures the pressure in the hydrogen supply manifold 56.

The other ends of the harness 5 (ends that branch off the portion opposite the end coupled to the controller 30) are electrically connected to the hydrogen filling pressure sensor 54, and the hydrogen supply pressure sensor 59 and the electromagnetic valve 57. Results of the detection (pressure detection signals) performed by the hydrogen filling pressure sensor 54 and the hydrogen supply pressure sensor 59 are input to the controller 30 via the harness 5.

One end of the second supply section 55B (the end opposite the end coupled to the hydrogen supply manifold 56) is connected to the decompression valve 35, which decompresses the fuel. The decompression valve 35 is provided between the second supply section 55B and the drive source 36. The decompression valve 35 is connected to the drive source 36. The decompression valve 35 has the function of releasing a high pressure in the second supply section 55B (primary side) to maintain the pressure in the drive source 36 (secondary side) at a predetermined pressure.

The drive source 36 includes a fuel cell (FC) that generates electricity by causing a chemical reaction between the hydrogen as a fuel gas and oxygen as an oxidizing gas, and a hydrogen engine that is an internal combustion engine using hydrogen as fuel. For example, the fuel cell has a stack structure in which multiple unit cells are stacked on each other. For example, the fuel cell generates electricity by using oxygen contained in the outside air. Note that an oxidizing gas supplier (not shown) may supply the fuel cell with air containing oxygen.

For example, the hydrogen engine generates power used to perform the dumping operation or the lowering operation of the dump body 12. For example, the hydrogen engine generates power used to steer the front wheels 21. For example, the power (rotational force) generated by the hydrogen engine is transmitted to the rear wheels 22 of the traveling apparatus 13.

Note that the hydrogen supply system 1 may include a battery (for example, secondary battery such as lithium ion battery). For example, the battery stores the electric power generated by the fuel cell. For example, the battery may function as a power source of the dump truck 2, as the fuel cell.

### Arrangement of Elements That Constitute System

For example, the drive source 36 is disposed forward of the decompression valve 35 in the vehicle body. The drive source 36 is disposed below the platform 17.

The drive source 36 and the decompression valve 35 are mounted on the vehicle body frame 10. The drive source 36 and the decompression valve 35 are preferably disposed within the vehicle body frame 10 in the vehicle width direction. According to the configuration described above, the drive source 36 and the decompression valve 35 are covered with the vehicle body frame 10 from below in the vehicle body. Disturbance (flying stones, for example) reaching the drive source 36 and the decompression valve 35 from below the vehicle body can thus be avoided.

For example, when abnormality such as a fire occurs in the vehicle body frame 10, the hydrogen in the hydrogen tanks 25 may need to be urgently discharged. In this case, the hydrogen discharge tube 58 may be extended to the upper end of the antenna pole 18 in the form of a tube branching off the hydrogen supply manifold 56. In the example shown in FIG. 3, the hydrogen discharge tube 58 extends in the vehicle's upward-downward direction along the antenna pole 18. Accordingly, the hydrogen gas can be discharged to the space above the dump body 12 via the discharger 58A of the hydrogen discharge tube 58.

Note that it is desirable to discharge the hydrogen at a highest possible position. Therefore, when the dump truck 2 is already equipped with the antenna pole 18, the hydrogen discharge tube 58 only needs to be extended to the upper end of the antenna pole 18 along the antenna pole 18. Therefore, the hydrogen discharge tube 58 is readily so installed that the hydrogen is discharged at a high position, and excellent safety is achieved.

### Effects and Advantages

As described above, the dump truck 2 according to the present embodiment is equipped with the drive source 36 using hydrogen as fuel. The dump truck 2 includes the hydrogen tanks 25, which store the hydrogen, and the hydrogen discharge tube 58, which includes the discharger 58A, which discharges the hydrogen gas from the hydrogen tanks 25. The discharger 58A discharges the hydrogen gas to the space above the dump truck 2.

According to the configuration described above, in which the discharger 58A discharges the hydrogen gas to the space above the dump truck 2, the hydrogen gas is less likely to accumulate in the vehicle body. The hydrogen can therefore be safely discharged into the atmosphere.

In the present embodiment, the dump truck 2 includes the vehicle body frame 10, which incorporates the drive source 36, and the dump body 12, which is pivotably coupled to the vehicle body frame 10 via the pivotal section 11 and accommodates a load. The discharger 58A is disposed at the front end portion of the dump truck 2.

According to the configuration described above, the hydrogen gas is more readily discharged from the discharger 58A to the space above the dump truck 2 than in a case where the discharger 58A is disposed in a rear portion of the dump truck 2. The hydrogen is therefore safely discharged into the atmosphere.

In the present embodiment, the discharger 58A is disposed at a position where the discharger 58A does not overlap with the dump body 12 in the plan view.

According to the configuration described above, the hydrogen gas discharged from the discharger 58A is less likely to be blocked by the dump body 12 than in a case where the discharger 58A overlaps with the dump body 12 in the plan view. The hydrogen can therefore be safely and more reliably discharged into the atmosphere.

In the present embodiment, the discharger 58A is disposed forward of the front end portion of the dump body 12 in the side view.

According to the configuration described above, the hydrogen gas discharged from the discharger 58A is less likely to be blocked by the dump body 12 than in a case where the discharger 58A is disposed rearward of the front end of the dump body 12 in the side view. The hydrogen can therefore be safely and more reliably discharged into the atmosphere.

In the present embodiment, the discharger 58A is disposed upward of the upper end of the dump body 12 in the front view.

According to the configuration described above, the hydrogen gas discharged from the discharger 58A is less likely to be blocked by the dump body 12 than in a case where the discharger 58A is disposed downward of the upper end of the dump body 12 in the front view. The hydrogen can therefore be safely and more reliably discharged into the atmosphere.

In the present embodiment, the dump truck 2 further includes the antenna pole 18 for transmission and reception of radio waves. The discharger 58A is disposed as a portion of the antenna pole 18.

According to the configuration described above, the hydrogen gas is more likely to be discharged from the discharger 58A to the space above the dump truck 2 than in a case where the discharger 58A is disposed as a portion of a member different from the antenna pole 18. The hydrogen is therefore safely discharged into the atmosphere. For example, when the dump truck 2 is already equipped with the antenna pole 18, the discharger 58A can be disposed at a high position by making use of the existing antenna pole 18. In addition, the configuration described above eliminates a need to newly provide a member that allows the discharger 58A to be disposed at a high position, contributing to reduction in the number of parts and cost.

In the present embodiment, the dump truck 2 further includes the plate-shaped platform 17 provided above the front portion of the vehicle body frame 10 in parallel to the vehicle's frontward-rearward direction and the vehicle width direction. The hydrogen discharge tube 58 passes along the lower surface of the platform 17.

According to the configuration described above, disturbance (falling stones, for example) reaching the hydrogen discharge tube 58 from above the vehicle can be avoided, as compared with a case where the hydrogen discharge tube 58 passes along the upper surface of the platform 17. In addition, even when the operator moves on the platform 17 at the time of getting on and off the operator's cab, at the time of maintenance of the incorporated equipment, or the like, a situation in which the hydrogen discharge tube 58 hinders the operator from doing so can be avoided.

### Variations

The aforementioned embodiment has been described with reference to the case where the discharger is disposed at the front end portion of the dump truck, but not necessarily. For example, the discharger may be disposed at a rear portion of the dump truck. For example, the aspect in which the discharger is disposed in the dump truck in the frontward-rearward direction of dump truck the can be changed in accordance with the design specifications.

The aforementioned embodiment has been described with reference to the case where the discharger is disposed at a position where the discharger does not overlap with the dump body in the plan view, but not necessarily. For example, the discharger may be disposed at a position where the discharger overlaps with the dump body in the plan view. For example, the aspect in which the discharger is disposed relative to the dump body in the plan view can be changed in accordance with the design specifications.

The aforementioned embodiment has been described with reference to the case where the discharger is disposed frontward of the front end of the dump body in the side view, but not necessarily. For example, the discharger may be disposed rearward of the front end of the dump body in the side view. For example, the aspect in which the discharger is disposed relative to the dump body in the side view can be changed in accordance with the design specifications.

The aforementioned embodiment has been described with reference to the case where the discharger is disposed upward of the upper end of the dump body in the front view, but not necessarily. For example, the discharger may be disposed downward of the upper end of the dump body in the front view. For example, the aspect in which the discharger is disposed relative to the dump body in the front view can be changed in accordance with the design specifications.

The aforementioned embodiment has been described with reference to the case where the dump truck further includes an antenna pole for transmission and reception of radio waves, but not necessarily. For example, the dump truck may include no antenna pole. For example, the aspect in which the antenna pole is installed can be changed in accordance with the design specification.

The aforementioned embodiment has been described with reference to the case where the discharger is disposed as a portion of the antenna pole, but not necessarily. For example, the discharger may be disposed as a portion of a member different from the antenna pole. For example, the discharger may be disposed at the dump body. For example, the aspect in the discharger is disposed can be changed in accordance with the design specification.

The aforementioned embodiment has been described with reference to the case where the dump truck further includes a plate-shaped platform provided above a front portion of the vehicle body frame in parallel to the vehicle's frontward-rearward direction and the vehicle width direction, but not necessarily. For example, the dump truck may include no platform. For example, the aspect in which the platform is disposed can be changed in accordance with the design specification.

The aforementioned embodiment has been described with reference to the case where the hydrogen discharge tube passes along the lower surface of the platform, but not necessarily. For example, the hydrogen discharge tube may pass along the upper surface or the side surface of the platform. For example, the aspect in which the hydrogen discharge tube is disposed can be changed in accordance with the design specification.

The aforementioned embodiment has been described with reference to the case where the hydrogen tanks are provided in the vehicle body frame, but not necessarily. For example, the hydrogen tanks may be provided in the dump body. For example, the hydrogen tanks may be provided below the protector in the dump body. For example, the aspect in which the hydrogen tanks are installed in the dump truck can be changed in accordance with the design specifications.

The aforementioned embodiment has been described with reference to the case where the decompression valve is provided between the second supply section and the drive source, but not necessarily. For example, the decompression valve may be provided at a location other than a location between the second supply section and the drive source. For example, the decompression valve may be provided in any of the first supply sections. For example, the aspect in which the decompression valve is disposed can be changed in accordance with the design specification.

The aforementioned embodiment has been described with reference to the case where the first and second supply sections are each configured with a metal tube, but not necessarily. For example, the first and second supply sections may each be configured with a tube other than a metal tube. For example, the first and second supply sections may each be configured with a high-pressure tube that can withstand the high-pressure hydrogen (about 70 MPa, for example). For example, the aspect in which the first and second supply sections are each configured can be changed according to the design specifications.

The aforementioned embodiment has been described with reference to the case where the hydrogen filling unit and the hydrogen supplying unit are configured to have hydrogen flow paths different from each other, but not necessarily. For example, at least portions of the hydrogen filling unit and the hydrogen supply unit may be configured to have the same hydrogen flow path. For example, the aspects of the hydrogen filling unit and the hydrogen supply unit can be changed in accordance with the design specification.

The aforementioned embodiment has been described with reference to the case where the work vehicle is a dump truck, but not necessarily. For example, the work vehicle may be another work vehicle such as a shovel, a bulldozer, or a wheel loader. For example, the aspect of the work vehicle can be changed in accordance with the design specifications.

The embodiment of the present invention and variations thereof have been described above, but the present invention is not limited thereto, and additions, omissions, substitutions, and other changes of the configurations can be made without departing from the intent of the present invention, and even the embodiment and the variations thereof described above can be combined with each other as appropriate.

### Appendix 1

A work vehicle equipped with a drive source using hydrogen as fuel, the work vehicle including:
a hydrogen tank configured to store the hydrogen; and
a hydrogen discharge tube including a discharger configured to discharge an evaporated gas from the hydrogen tank,
in which the discharger discharges the evaporated gas to a space above the work vehicle.

### Appendix 2

The work vehicle according to Appendix 1, in which
the work vehicle is a dump truck,
the dump truck includes
a vehicle body frame equipped with the drive source, and
a dump body pivotably coupled to the vehicle body frame via a pivotal portion and configured to accommodate a load, and
the discharger is disposed at a front end portion of the dump truck.

### Appendix 3

The work vehicle according to Appendix 2, in which
the discharger is disposed at a position where the discharger does not overlap with the dump body in a plan view.

### Appendix 4

The work vehicle according to Appendix 2 or 3, in which
the discharger is disposed forward of the front end portion of the dump body in a side view.

### Appendix 5

The work vehicle according to any one of Appendices 2 to 4, in which
the discharger is disposed above an upper end of the dump body in a front view.

### Appendix 6

The work vehicle according to any one of Appendices 1 to 5, further including
an antenna pole for transmission and reception of radio waves,
in which the discharger is disposed at the antenna pole.

### Appendix 7

The work vehicle according to any one of Appendices 2 to 5, further including
a plate-shaped platform provided above a front portion of the vehicle body frame in parallel to a vehicle's frontward-rearward direction and a vehicle width direction,
in which the hydrogen discharge tube passes along a lower surface of the platform.

### REFERENCE SIGNS LIST

2 Dump truck
10 Vehicle body frame
11 Pivotal portion
12 Dump body
17 Platform
18 Antenna pole
25 Hydrogen tank
36 Drive source
58 Hydrogen discharge tube
58A discharger

1. A work vehicle equipped with a drive source using hydrogen as fuel, the work vehicle comprising:
a hydrogen tank configured to store the hydrogen; and
a hydrogen discharge tube including a discharger configured to discharge an evaporated gas from the hydrogen tank,
wherein the discharger discharges the evaporated gas to a space above the work vehicle.

2. The work vehicle according to claim 1, wherein
the work vehicle is a dump truck,
the dump truck includes
a vehicle body frame equipped with the drive source, and
a dump body pivotably coupled to the vehicle body frame via a pivotal portion and configured to accommodate a load, and
the discharger is disposed at a front end portion of the dump truck.

3. The work vehicle according to claim 2, wherein
the discharger is disposed at a position where the discharger does not overlap with the dump body in a plan view.

4. The work vehicle according to claim 2, wherein the discharger is disposed forward of the front end portion of the dump body in a side view.

5. The work vehicle according to claim 2, wherein the discharger is disposed above an upper end of the dump body in a front view.

6. The work vehicle according to claim 1, further comprising
an antenna pole for transmission and reception of radio waves,
wherein the discharger is disposed at the antenna pole.

7. The work vehicle according to claim 2, further comprising
a plate-shaped platform provided above a front portion of the vehicle body frame in parallel to a vehicle's frontward-rearward direction and a vehicle width direction,
wherein the hydrogen discharge tube passes along a lower surface of the platform.

8. The work vehicle according to claim 3, wherein
the discharger is disposed forward of the front end portion of the dump body in a side view.

9. The work vehicle according to claim 3, wherein
the discharger is disposed above an upper end of the dump body in a front view.

10. The work vehicle according to claim 2, further comprising
an antenna pole for transmission and reception of radio waves,
wherein the discharger is disposed at the antenna pole.

11. The work vehicle according to claim 3, further comprising
an antenna pole for transmission and reception of radio waves,
wherein the discharger is disposed at the antenna pole.

12. The work vehicle according to claim 3, further comprising
a plate-shaped platform provided above a front portion of the vehicle body frame in parallel to a vehicle's frontward-rearward direction and a vehicle width direction,
wherein the hydrogen discharge tube passes along a lower surface of the platform.
